(19) United States
(12) Patent Application Publication
(10) Pub. No.: US 2015/0300012 A1
(43) Pub. Date: Oct. 22, 2015

(54) Storefront Cladding System

(71) Applicant: Brandon Kelley, Carpinteria, CA (US)

(72) Inventor: Brandon Kelley, Carpinteria, CA (US)

(21) Appl. No.: 14/255,794

(22) Filed: Apr. 17, 2014

(51) Int. Cl. E04B 2/90; E06B 3/54

(52) U.S. Cl. CPC E04B 2/90; E06B 3/549

(57) ABSTRACT

A retrofit cladding system that allows a home, office, or building to replace its cladding without having to remove the foundational frames utilizing at least one frame clip that can attach to the foundational frame structure of the home, office, building, and a plurality of cladding members that can attach to the foundational frame or the frame clip to cover the foundational frame and provide support for a window.

### TECHNICAL FIELD

This invention relates to a method and system for changing claddings on a building without having to remove the foundational frames.

### BACKGROUND

A building may have an ornate storefront, where large glass windows are held in by aluminum frames to attract potential customers to walk in. For example, most modern malls, convenience stores, and supermarkets have aluminum storefronts with large windows. Although aluminum is durable and corrosion resistant, eventually a storefront will look worn and dated. To update such storefronts, usually the entire storefront must be replaced, including the aluminum frames. This requires demolition of the old storefront and starting the installation from scratch, even though the existing storefront framing is still structurally sound.

Therefore, what is needed is a lower-cost method of updating a storefront without complete removal of the framing and/or glass.

### SUMMARY

The present invention is directed to a cladding system that can be installed on storefront framing systems so that the frames have a new look without having to remove the existing frames or replace the glass. Frame clips may be used to allow the cladding system to be quickly and easily installed on the frames. Thus, rather than removing foundational frames, only the non-foundational components of the frame need be removed, leaving the foundational frames intact. Frame clips, as necessary, can be installed on the foundational frames, and the new claddings can be installed on the foundational frame either by clipping the claddings onto frame clips and/or directly onto the frames themselves. Therefore, the invention of the present application minimizes the number of components required for installing new claddings, and makes the installation easier with the frame clips without compromising the integrity of the attachment.

### BRIEF DESCRIPTION OF DRAWINGS

FIG. 1 shows a perspective view of an embodiment of a frame clip.

FIG. 2 shows a partial perspective view of an embodiment of a cladding member.

FIG. 3 shows a cross-section of an embodiment of the cladding members installed on a foundational frame.

FIG. 4 shows a cross-section of another embodiment of the cladding members installed on a foundational frame.

FIG. 5 shows a cross-section of another embodiment of the cladding members installed on a foundational frame.

FIG. 6 shows a cross-section of another embodiment of the cladding members installed on a foundational frame.

FIG. 7 shows a cross-section of another embodiment of the cladding members installed on a foundational frame.

FIG. 8 shows a cross-section of another embodiment of the cladding members installed on a foundational frame.

### DETAILED DESCRIPTION OF THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

The present invention is directed towards a retrofit cladding system that allows a home, office, building, and the like to replace its cladding without having to remove the foundational frames. For example, a building may have an ornate storefront including one or more display windows to attract potential customers to walk in. The storefront can fade or become damaged, or the owner may wish to update or upgrade the storefront. The display windows are held up by frames. In order to update a storefront, the entire storefront, including the frames, must be replaced. With the invention of the present application, however, the frames can remain intact, and only the claddings and possibly the display window would need changing.

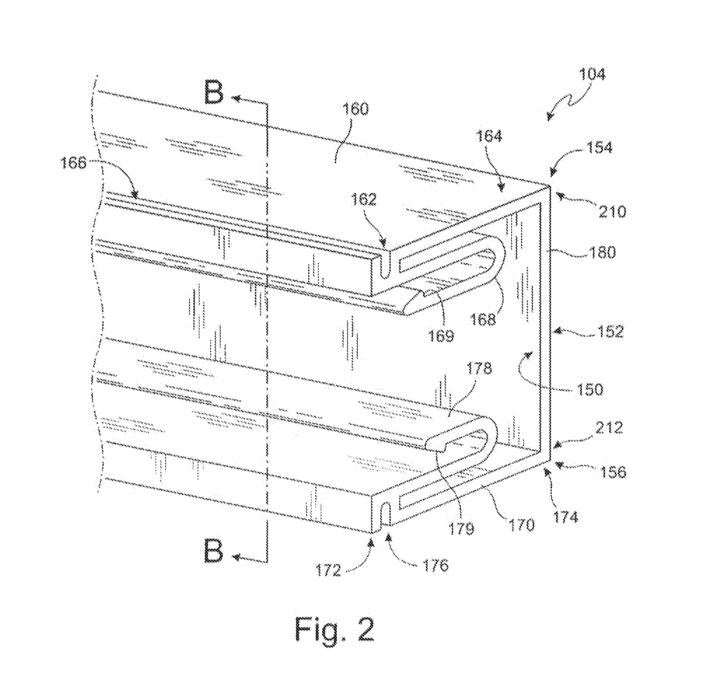

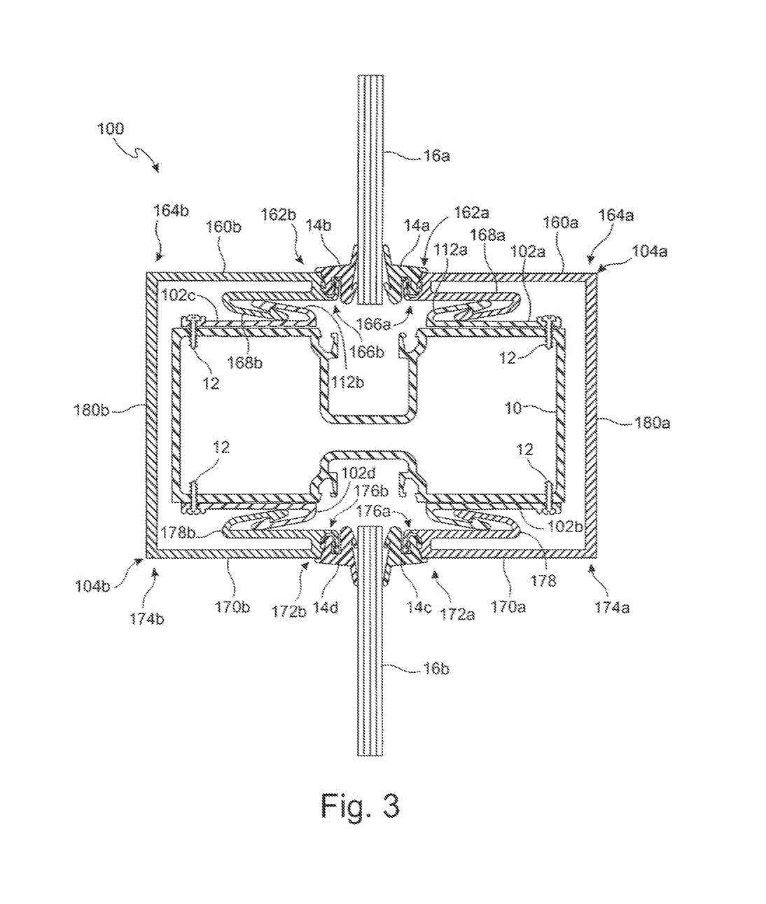

As shown in FIGS. 3-8, the retrofit cladding system 100 comprises at least one frame clip 102a attachable to the frame 10, and at least one cladding member 104a attachable to the frame clip 102a and/or the frame 10 itself. The cross-sectional views of FIGS. 3-8 are generally taken through lines B-B shown in FIG. 2, but when properly installed for each respective embodiment. The number of frame clips 102a-d and cladding members 104a, b required depends on the frame 10 structure. The frame clips 102a-d and the cladding members 104a, b are configured so that the frame clips 102a-d can be attached to the frame 10 by any fastening means 12, such as screws, nails, adhesives, book and loop fasteners, magnets, and the like, and any combination thereof. In the preferred embodiment, a cladding member 104 is configured to simply slide into a frame clip 102 and snap together.

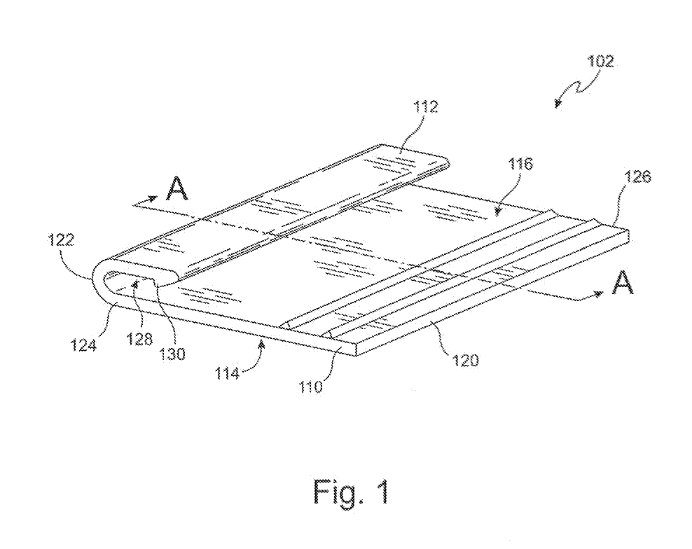

As shown in FIG. 1, in general, a frame clip 102 comprises a base member 110 and a hook member 112. The base member 110 may be a thin flat piece of material that is placed flat against the frame 16 and secured to the frame 10 by any type of fastener 12. In the preferred embodiment, the base member 110 may be screwed into the frame 10. Preferably, the base member 110 is rectangular in shape having a first side 114 that can be placed flat against the frame, and a second side 116 opposite the first side 114 facing away from the frame, the first and second sides 114, 116 being bound by a first end 126, a second end 122 opposite and parallel to the first end 120, a third end 124 perpendicular to the first and second ends 120, 122, and a fourth end 126 opposite and parallel to the third end 124 and perpendicular to the first and second ends 120, 122. Although the preferred embodiment has been described generally as a rectangle, other shapes can be used for the frame clip 102.

In the preferred embodiment, the hook member 112 emerges front one of the ends (e.g. end 122) and curves or bends towards the second side 116, then towards the opposite end (e.g. end 120) to create a hairpin turn. The free end 128 may comprise a lip 130 projecting transversely from the hook member 112. This lip 130 can provide a catch onto which the cladding member 104 may be secured. In some embodiments, the free end 128 may taper as it moves away from the lip 130 and towards its terminus. This taper facilitates the connection with the cladding member 104 as discussed below.

In some embodiments, multiple frame clips 102a-d may be used to secure a single cladding member 104 or multiple cladding members 104a, 104b. Therefore, a second frame clip 102b comprising a second base member 110b and a second hook member 112b may be attached to the frame 10 in strategic locations to create additional attachment points for the cladding member 104 or members 104a, 104b.

The cladding member 104 is configured to cover or substantially cover the frame 10. It may also provide support for a window. In the preferred embodiment, multiple cladding members 104a, 104b may work together to cover or substantially cover the frame 10 as shown in FIG. 3-8. As shown in FIG. 2, in general, a cladding member 104 is generally an elongated member having an inner side 150 and an outer side 152, and one or more bends 154, 156 to wrap (at least partially) around frame 10. The inner side 150 of the cladding member 104 is configured to attach to one or more frame clips 102 and/or attach directly to the frame 10, while the outer side 152 presents an aesthetic appearance and/or a protective covering. For example, the inner side 150 may comprise one or more reciprocal clips 168, 178 configured to attach to a frame clip 102. In some embodiments, the inner side may also comprise one or more posts 220 projecting perpendicularly from any arm 160, 170, 180 configured to be abuttable (or capable of abutting) against the frame 10 when properly installed.

In some embodiments, the cladding member 104 has a first arm 160 having a first end 162 and a second end 164 opposite the first end 162, a second arm 170 opposite and parallel to the first arm 160, the second arm 170 having a third end 172 and a fourth end 174 opposite the third end 172, and a first adjoining arm 180 operatively connecting the first arm 160 with the second arm 170, preferably, through the second and fourth ends 164, 174, respectively. In the preferred embodiment, the adjoining arm 180 may be perpendicular to the first and second arms 160, 170. Therefore, this embodiment has a generally U-shaped appearance. However, other arrangements may be used for different appearances or functions.

The connection between the adjoining arm 180 and the first and second arms 160, 170 may result from separate pieces being attached together or a single piece of material integrally formed and bent at the bends 154, 156. Therefore, the terms “connect” or “operatively connect,” and variations thereof, do not necessarily mean separate, multiple pieces being attached together. Rather, it more broadly designates a transition point to be able to refer to different components, parts, or features in a convenient manner.

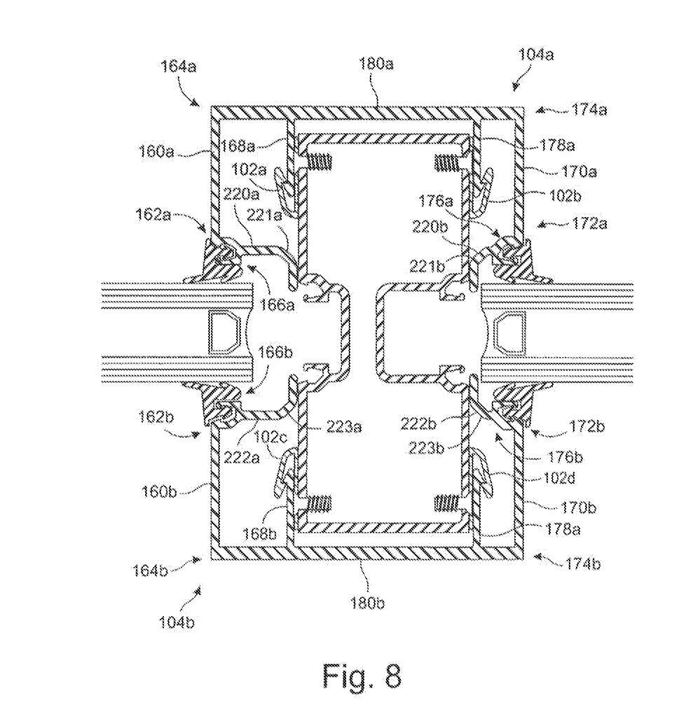

The first arm 160 comprises a first channel 166 formed at the first end 162, and a first reciprocal clip 168 stemming from the first arm 160. In some embodiments, as shown in FIG. 8, the first reciprocal clip 168a may stem from the adjoining arm, but be adjacent to the first arm 160a. The first reciprocal clip 168 may be used to attach the cladding member 104 to a first frame clip 102a and/or the frame 10 itself. The second arm 170 comprises a second channel 176 formed at the third end 172, and a second reciprocal clip 178 stemming from the second arm 170 that is attachable to a second frame clip 102b and/or the frame 10 itself. In some embodiments, as shown in FIG. 8, the second reciprocal clip 178a may project from the adjoining arm 180, but be adjacent to the second arm 170a. In some embodiments, the reciprocal clips 168, 178 look much like a frame clip 102, but facing in an opposite orientation relative to the frame clip 102. In some embodiments, the reciprocal clips 168, 178 may be straight members with a lip 169, 179 at a free end. The idea is to allow the reciprocal clip 168 or 178 to slide into the frame clip 102 and have their respective lips 169 or 179, and 130 engage one another.

In some embodiments, this may be sufficient to cover one side of the frame 10. In such a case, a second cladding member 104b may be used to cover the opposite side of the frame 10 as shown in FIGS. 3-8. The second cladding member 104b may comprise a third arm 160b having a fifth end 162b and a sixth end 164b opposite the fifth end 162b, a fourth arm 170b opposite and parallel to the third arm 160b, the fourth arm 170b having a seventh end 172b and an eighth end 174b opposite the seventh end 172b, and a second adjoining arm 180b imperatively connecting the third arm 160b with the fourth arm 170b through the sixth and eighth ends 164b, 174b, respectively. The second adjoining arm 180b may be perpendicular to the third and fourth arms 160b, 170b. The third arm 160b may comprise a third channel 166b formed at the fifth end 162b, and a third reciprocal clip 168b stemming from the third arm 160b and attachable to a third frame clip 102c and/or the frame 10 itself. In some embodiments, the third reciprocal clip 168b may stem from she adjoining arm 180b, but he adjacent to the third arm 160b, as shown in FIG. 8.

The fourth arm 170b may comprise a fourth channel 176b formed at the seventh end 172b, and a fourth reciprocal clip 178b stemming from the fourth arm 170b. In some embodiments, the fourth reciprocal clip 178b may stem from the adjoining arm 180b, hot be adjacent to the fourth arm 170b, as shown in FIG. 8. The fourth reciprocal clip 178b can be attached to a fourth frame clip 102d and/or the frame 10 itself. Once both cladding members 104a, 104b have been properly attached to the frame 10, the first and second cladding members 104a, 104b cover at least substantially all of the frame 10.

Once the first and second cladding members 104a, 104b are properly installed, the first and third channels 166a, 166b may be adjacent to each other, but separated by a gap. Similarly, the second and fourth channels 176a, 176b may be adjacent to each other, hot separated by a gap. The channels are configured to receive and hold individual gaskets 14a-d so that a window 16a or 16b can be placed into the gap, in between the gaskets 14a-d. The gaskets 14a-dcreate a water and wind-tight seal against the window 16a or 16b, and the cladding members 104a, 104b create a support structure for the windows 16a, 16b. Once the cladding system 100 is completely assembled with the gaskets 14a-d and windows 16a, b, the frame 10 may be completely covered and hidden from the customers. This particular type of configuration is designed for non-end unit frames or frames in which windows 16a, 16b are needed on opposite sides, as shown in FIGS. 3, 4, 7, and 8.

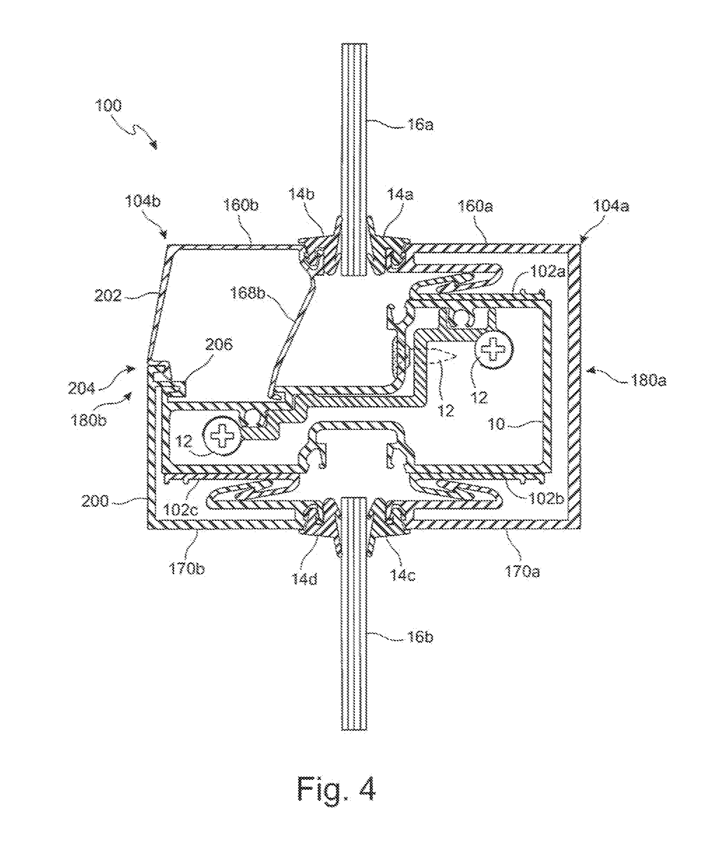

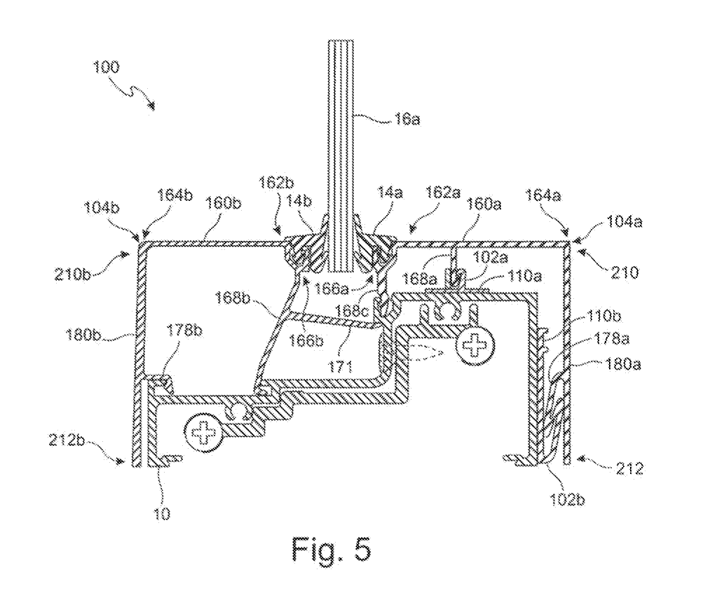

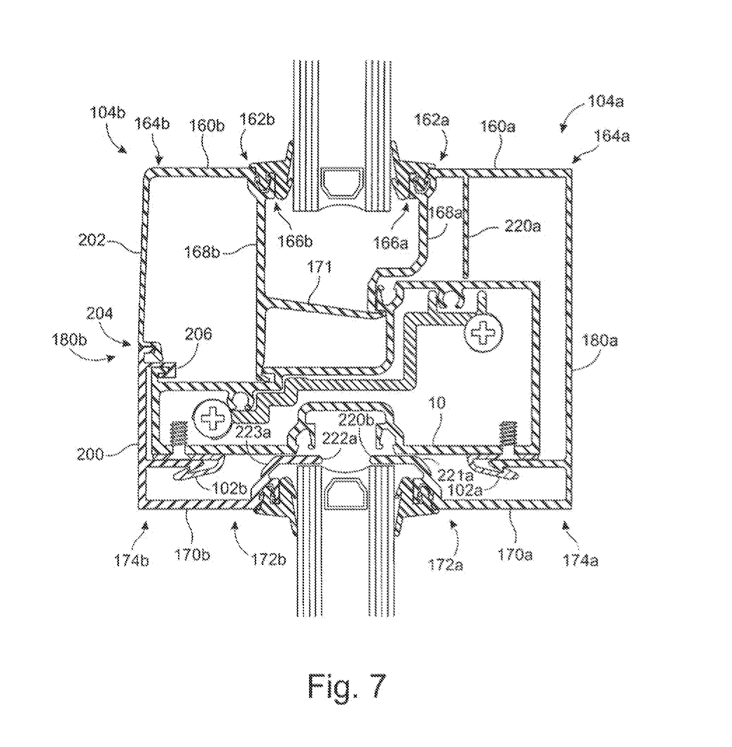

Different variations of this concept can be used depending on the configuration of the frame 10. For example, in some embodiments, as shown in FIGS. 4 and 7, there may not be a convenient location to place one of the frame clips 102a-d to properly secure or stabilize all of the arms of the cladding members. In such an embodiment, one or more of the reciprocal clips (168b for example) may have to be configured to attach directly to the frame 10. In some embodiments, for example with thick, insulated, or double pane windows, an auxiliary clip 171 may be used to further stabilize the connection. As shown in the example in FIG. 7, the auxiliary clip 171 may stem from the reciprocal clip (168b for example) as a crossbar to connect to the frame on the opposite side. In some embodiments, as shown in FIGS. 4 and 7, one or more of the cladding members (104b for example) may be a two piece member having a first member 200 and a second member 202 that are attached to each other at the adjoining arm 180b by a fastening mechanism 204. Preferably, this type of attachment is via a snap-fit connection, although any type of fastening mechanism can be used. For added stability, the adjoining arm 180b may have a fifth reciprocal clip 206 attachable to the frame 10. In some embodiments, any of the arms 160a, 170a, 180a, 160b, 170b, 180b can have a post 220a, 220b, 222a, 222b projecting therefrom to be abuttable against the foundational frame 10 for added support as shown in FIG. 8, as necessary or desired. In some embodiments, any of the posts 220a, 220b, 222a, 222b can also function as a reciprocal clip 168a as shown in FIG. 5. In some embodiments, where the posts 220a, 220b, 222a, 222b approaches the foundational frame when properly installed, the posts 220a, 220b, 222a, 222b may have a medial bend 221a, b, 223a, b causing the free ends of the posts 220a, 220b, 222a, 222b to bend medially in the direction of the gap as shown in FIGS. 7 and 8. This could provide a wall to prevent the window from be inserted too deeply. In some embodiments, the posts 220a, 220b, 222a, 222b may stem from directly beneath their respective channel 166a, 176a, 166b, 176b, on the opposite side of the channel to provide added support at the channel as shown in FIGS. 5 and 8. In some embodiments, any of the posts 220a, 220b, 222a, 222b may also function as a reciprocal clip attachable to the frame 10 as shown in FIGS. 5 and 7.

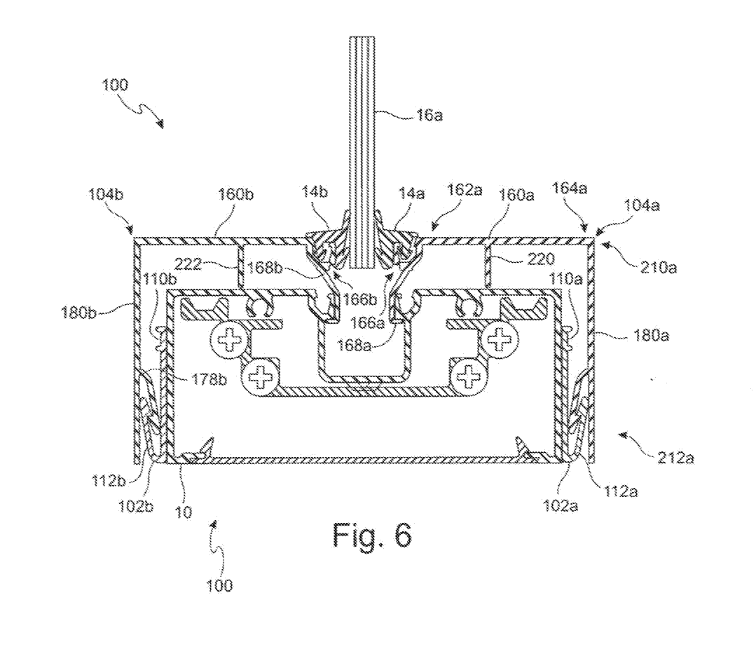

The cladding system 100 can be modified to apply to end-unit frames in which a window 16a is needed on only one side, as shown in FIGS. 5 and 6. In such an embodiment, the retrofit cladding system 100 may comprise one or more frame clips 102a, 102b, each frame clip having a base member 110a, 110b and a hook member 112a, 112b. The first cladding member 104a may comprise a first arm 160a having a first end 162a and a second end 164a opposite the first end 162a, and a first adjoining arm 180a having a third end 210a and a fourth end 212a opposite the third end 210a, the first adjoining arm 180a operatively connected to the first arm 160a at the second and third ends 164a, 210a. Preferably, the first adjoining arm 180a is perpendicular to the first arm 160a. The first arm 160a may comprise a first channel 166a formed at the first end 162a, and a first reciprocal clip 168a adjacent to the first arm 160a, and attachable to a frame clip 102a and/or the frame 10 itself. The first adjoining arm 180a may comprise a second reciprocal clip 178a attachable to another frame clip 182b or the frame 10 itself.

Similarly, a second cladding member 104b may be attached to the frame 10 opposite the first cladding member 104a. The second cladding member 104b may comprise a second arm 160b having a fifth end 162b and a sixth end 164b opposite the fifth end 162b, and a second adjoining arm 180b having a seventh end 210b and an eighth end 212b opposite the seventh end 210b, the second adjoining arm 180b operatively connected to the second arm 160b at the sixth and seventh ends 164b, 210b. Preferably, the second adjoining arm 180b is perpendicular to the second arm 160b. The second arm 160b comprises a second channel 166b formed at the fifth end 162b, and a third reciprocal clip 168b attachable to a frame clip 102 and/or the frame 10 itself. The second adjoining arm 180b may comprise a fourth reciprocal clip 178b attachable to a frame clip 102b and/or the frame 10 itself. Once the first and second cladding members 104a, 104b are properly installed, the frame 10 is at least substantially covered with a gap formed between the two channels 166a, 166. The channels 166a, 166b are configured to receive gaskets 14a, 114b, in between which, a window 16a can be installed as discussed above.

Like the previous embodiments, the end-unit embodiment can have a number of variations. For example, the reciprocal clips 168a, 168b, 178a, 178b can project from any of me arms 160a, 160b, 180a, 180b. In some embodiments, any of the arms 160a, 160b, 180a, 180b may have a post 220, 222 projecting perpendicularly from the arm and capable of abetting against the frame 10 when properly installed. For example, in FIG. 6, the first arm 160a has a post 220 extending perpendicularly therefrom and abuttable against the foundational frame 10. Thus, when pressure is applied perpendicularly to the first arm 160, the first post 220 helps to support or resist the pressure. Similarly, the second arm 160b of the second cladding member 104b may comprise a second post 222 projecting perpendicularly from the second arm 160b and capable of abutting against the frame 10 when properly installed. Any other arm can have a post as necessary or desired. In some embodiments, such as that shown in FIG. 5, the reciprocal clips 168a, 168b can function as fasteners and posts due to their transverse or perpendicular arrangement relative to their respective arms 160a, 160b. In some embodiments, the reciprocal clips 168b, c may extend from the bottom of the channel 166a, 166b to provide support at the channels 166a, 166b as well as serving as a fastener to the frame 10 directly or through frame clips.

In use, an existing storefront framing system can be retrofitted with new cladding by removing the non-foundational components of the storefront framing to expose a foundational frame 10, fastening a first frame clip 102a to the foundational frame 10, fastening a first retrofit cladding member 104a to the foundational frame 10 via the first frame clip 102a to substantially cover one side of the foundational frame 10, fastening a second retrofit cladding member 104b to the foundational frame 10 to substantially cover an opposite side of the foundational frame 10. Due to the parallel configuration of the frame clips 102 and the arms of the cladding members 104 when properly positioned, the cladding member 104 is able to slide onto the frame clips 102 very quickly and easily. When the gaskets 14a-d and the windows 16a, 16b are installed, a force is created on the cladding members 104 to lock the cladding member 104 to its frame clip 102.

When the first retrofit cladding member 104 and the second retrofit cladding member 104b are properly installed, the foundational frame 10 is at least substantially covered by the first and second retrofit claddings members 104a, 104b. A small gap may exist between two claddings 104a, 104b. A pair of gaskets 14a, 14b can be inserted into respective channels 166a, 166b defined by the cladding so that the gaskets 14a, 14b are in between the first and second claddings 104a, 104b. A window 16a can be inserted in between the gaskets 14a, 14b. This system minimizes that number of components required and the quick snap fits make it is easy to install a new cladding to an existing storefront, while providing surprisingly secure attachments.

The order of events can be modified in any logical order. For example, the first cladding 104a may be installed, then the first gasket inserted 14a. The window 16a may be position against the first gasket 14a. The second cladding 104b can then be installed and the second gasket 14b inserted in between the second cladding 104b and the window 10.

In some embodiments, a plurality of frame clips 104a-d may be installed on the frame so that the reciprocal clips 168a, 168b, 178a, 178b can be attached to the frame via the frame clips 104a-d instead of directly to the frame 111. Any combination of attachments of reciprocal clips attaching to frame clips or to the frame directly can be used depending on the structure of the frame.

The frame clips 102 and cladding members 104 can be made of any sturdy material, such as metal, plastic, and the like, or any combination thereof using known methods in the art.

The foregoing description of the preferred embodiment of the invention has been presented for the purposes of illustration and description. Features of the different embodiments shown are not necessarily mutually exclusive. As such, features shown in one embodiment can be applied to other embodiments. Therefore, it is not intended to be exhaustive or to limit the invention to the precise form disclosed. For example, reference to ordinal numbers (such as first, second, third, etc.) does not limit the structure to the specific embodiment shown or referenced, but rather, are relative based on the number of similar structures previously recited for ease of description only. Many modifications and variations are possible in light of the above teaching. It is intended that the scope of the invention not be limited by this detailed description, but by the claims and the equivalents to the claims appended hereto.

What is claimed is:

1. A method for retrofitting an existing storefront framing system with new cladding, comprising:
a. removing non-foundational components of the storefront framing to expose a foundational frame;
b. fastening a frame clip to the foundational frame;
c. fastening a first cladding member to the foundational frame via the frame clip by sliding the first cladding member towards the foundational frame to substantially cover one side of the foundational frame, wherein the first cladding member comprises:
i. a first arm having a first end and a second end opposite the first end, wherein the first arm comprises a first channel formed at the first end,
ii. a first adjoining arm having a third end and a fourth end opposite the third end, the first adjoining arm operatively connected to the first arm at the second and third ends opposite the first channel, the first adjoining arm perpendicular to the first arm, and
iii. a first reciprocal clip attachable to the frame clip;
d. fastening a second cladding member to the foundational frame by sliding the second cladding member towards the foundational frame to substantially cover an opposite side of the foundational frame, wherein the second cladding member comprises:
i. a second arm having a fifth end and a sixth end opposite the fifth end, wherein the second arm comprises a second channel formed at the fifth end,
ii. a second adjoining arm having a seventh end and an eighth end opposite the seventh end, the second adjoining arm operatively connected to the second arm at the sixth and seventh ends opposite the second channel, the second adjoining arm perpendicular to the second arm, and
iii. a second reciprocal clip attachable to the foundational frame,
e. whereby when the first cladding member and the second cladding member are properly installed, the foundational frame is at least substantially covered by the first and second cladding members.

2. The method of claim 1, further comprising fastening a second frame clip to the foundational frame and fastening the second cladding member to the foundational frame via the second frame clip.

3. The method of claim 1, further comprising fastening a plurality of frame clips to the foundational frame and fastening the first and second cladding members to the foundational frame via the plurality of frame clips.

4. The method of claim 1, further comprising installing a pair of gaskets in between the first and second cladding members, the pair of gaskets defining a gap therebetween.

5. The method of claim 4, further comprising installing a window in between the pair of gaskets, wherein the gaskets create a seal against the window.

6. A retrofit cladding system, comprising:
a. a first frame clip comprising a first base member and a first hook member, wherein the first frame clip is attachable to a foundational frame;
b. a first cladding member attachable to the first and second frame clips, the first cladding member comprising:
i. a first arm having a first end and a second end opposite the first end, the first arm comprising a first channel formed at the first end,
ii. a second arm opposite and parallel to the first arm, the second arm having a third end and a fourth end opposite the third end, the second arm comprising a second channel formed at the third end,
iii. a first adjoining arm operatively connecting the first arm with the second arm through the second and fourth ends, respectively, the adjoining arm being perpendicular to the first and second arms,
iv. a first reciprocal clip attachable to the first frame clip to secure the first arm to the foundational frame, and
v. a second reciprocal clip attachable to the foundational frame;
c. a second frame clip comprising a second base member and a second hook member, wherein the second frame clip is attachable to the foundational frame;
d. a second cladding member attachable to the second frame clip, the second cladding member comprising:
i. a third arm having a fifth end and a sixth end opposite the fifth end, the third arm comprising a third channel formed at the fifth end, and
ii. a fourth arm opposite and parallel to the third arm, the fourth arm having a seventh end and an eighth end opposite the seventh end, the fourth arm comprising a fourth channel formed at the seventh end,
iii. a second adjoining arm operatively connecting the third arm with the fourth arm through the sixth and eighth ends, respectively, the second adjoining arm perpendicular to the third and fourth arms,
iv. a third reciprocal clip attachable to the second frame clip to secure the third arm to the foundational frame, and
v. a fourth reciprocal clip to secure the fourth arm to the foundational frame,
e. wherein the first and second cladding members cover at least substantially all of the foundational frame when properly installed.

7. The retrofit cladding system of claim 6, further comprising a third frame clip attachable to the foundational frame, wherein the second reciprocal clip attaches to the foundational frame via the third frame clip.

8. The retrofit cladding system of claim 7, further comprising a fourth frame clip, wherein the fourth reciprocal clip is attachable to the foundational frame via the fourth frame clip.

9. The retrofit cladding system of claim 6, wherein the second cladding member is a two piece member having a first member and a second member connected to each other at the second adjoining arm via a snap-fit connection.

10. The retrofit cladding system of claim 9, wherein the second adjoining arm comprises a fifth reciprocal clip attachable to the foundational frame.

11. The retrofit cladding system of claim 6, wherein at least one of the first or second cladding members comprises a post that is abuttable against the foundational frame.

12. A retrofit cladding system, comprising:
a. a first frame clip comprising a first base member and a first hook member, wherein the first frame clip is attachable to a foundational frame; and
b. a first cladding member attachable to the first frame clip, the first cladding member comprising:
i. a first arm having a first end and a second end opposite the first end, the first arm comprising a first channel formed at the first end,
ii. a first adjoining arm having a third end and a fourth end opposite the third end, the first adjoining arm operatively connected to the first arm at the second and third ends, the first adjoining arm perpendicular to the first arm,
iii. a first reciprocal clip attachable to the foundational frame to secure the first cladding member to the foundational frame, and
iv. a second reciprocal clip attachable to the first frame clip to secure the first cladding member to the foundational frame; and
c. a second cladding member attachable to the foundational frame, the second cladding member comprising:
i. a second arm having a fifth end and a sixth end opposite the fifth end, the second arm comprising a second channel formed at the fifth end,
ii. a second adjoining arm having a seventh end and an eighth end opposite the seventh end, the second adjoining arm operatively connected to the second arm at the sixth and seventh ends, the second adjoining arm perpendicular to the second arm,
iii. a third reciprocal clip attachable to the foundational frame, and
iv. a fourth reciprocal clip attachable to the foundational frame, wherein the third and fourth reciprocal clips help secure the second cladding to the foundational frame, and
d. wherein the first and second claddings cover at least substantially all of the foundational frame when properly installed.

13. The retrofit cladding system of claim 12, further comprising a second frame clip attachable to the foundational frame, wherein the first reciprocal clip attaches to the foundational frame through the second frame clip.

14. The retrofit cladding system of claim 12, further comprising a second frame clip attachable to the foundational frame, wherein the fourth reciprocal clip attaches to the foundational frame through the second frame clip.

15. The retrofit cladding system of claim 12, wherein the first arm of the first cladding member further comprises a post projecting perpendicularly from the first arm and capable of abutting against the foundational frame when properly installed.

16. The retrofit cladding system of claim 15, wherein the second arm of the second cladding member further comprises a post projecting perpendicularly from the second arm and capable of abutting against the foundational frame when properly installed.

17. A method for retrofitting an existing storefront framing system with new cladding, comprising:
a. removing non-foundational components of the storefront framing to expose a foundational frame;
b. fastening a frame clip to the foundational frame;
c. fastening a first cladding member to the foundational frame via the frame clip to substantially cover one side of the foundational frame;
d. fastening a second cladding member to the foundational frame to substantially cover an opposite side of the foundational frame;
e. inserting a window in between the first cladding member and the second cladding member,
whereby when the first cladding member and the second cladding member are properly installed, the foundational frame is at least substantially covered by the first and second cladding members.

18. The method of claim 17, wherein the first cladding member comprises:
a. a first arm having a first end and a second end opposite the first end, wherein the first arm comprises a first channel formed at the first end,
b. a first adjoining arm having a third end and a fourth end opposite the third end, the first adjoining arm operatively connected to the first arm at the second and third ends, the first adjoining arm perpendicular to the first arm, and
c. at least one reciprocal clip attachable to the frame clip.

19. The method of claim 18, wherein the second cladding member comprises:
a. a second arm having a fifth end and a sixth end opposite the fifth end, wherein second arm comprises a second channel formed at the fifth end, and a third reciprocal clip attachable to the foundational frame, and
b. a second adjoining arm having a seventh end and an eighth end opposite the seventh end, the second adjoining arm operatively connected to the second arm at the sixth and seventh ends, the second adjoining arm perpendicular to the second arm, and
c. at least one reciprocal clip attachable to the foundational frame.

20. The method of claim 18, wherein fastening the second cladding member to the foundational frame comprises:
a. fastening a second frame clip to the foundational frame; and
b. fastening the second cladding member to the second frame clip.
